(19) United States
(12) Patent Application Publication
(10) Pub. No.: US 2024/0153484 A1
(43) Pub. Date: May 9, 2024

(54) MASSIVE MULTILINGUAL SPEECH-TEXT JOINT SEMI-SUPERVISED LEARNING FOR TEXT-TO-SPEECH

(71) Applicant: Google LLC, Mountain View, CA (US)

(72) Inventors: Andrew M. Rosenberg, Brooklyn, NY (US); Takaaki Saeki, Mountain View, CA (US); Zhehuai Chen, Edgewater, NJ (US); Byungha Chun, Tokyo (JP); Bhuvana Ramabhadran, Mt. Kisco, NY (US)

(73) Assignee: Google LLC, Mountain View, CA (US)

(21) Appl. No.: 18/494,324

(22) Filed: Oct. 25, 2023

Related U.S. Application Data
(60) Provisional application No. 63/381,077, filed on Oct. 26, 2022.

(51) Int. Cl. G10L 13/047; G10L 15/06; G10L 15/16

(52) U.S. Cl. CPC G10L 13/047; G10L 15/063; G10L 15/16

(57) ABSTRACT

A method includes receiving training data that includes a plurality of sets of text-to-speech (TTS) spoken utterances each associated with a respective language and including TTS utterances of synthetic speech spoken that includes a corresponding reference speech representation paired with a corresponding input text sequence. For each TTS utterance in each set of the TTS spoken training utterances of the received training data, the method includes generating a corresponding TTS encoded textual representation for the corresponding input text sequence, generating a corresponding speech encoding for the corresponding TTS utterance of synthetic speech, generating a shared encoder output, generating a predicted speech representation for the corresponding TTS utterance of synthetic speech, and determining a reconstruction loss. The method also includes training a TTS model based on the reconstruction losses determined for the TTS utterances in each set of the TTS spoken training utterances.

### CROSS REFERENCE TO RELATED APPLICATIONS

This U.S. Patent Application claims priority under 35 U.S.C. § 119(e) to U.S. Provisional Application 63/381,077, filed on Oct. 26, 2022. The disclosure of this prior application is considered part of the disclosure of this application and is hereby incorporated by reference in its entirety.

### TECHNICAL FIELD

This disclosure relates to massive multilingual speech-text joint semi-supervised learning for text-to-speech.

### BACKGROUND

Text-to-speech (TTS) systems read aloud digital text to a user and are becoming increasingly popular on mobile devices. Certain TTS models aim to synthesize various aspects of speech, such as speaking styles and languages, to produce human-like, natural sounding speech. Some TTS models are multilingual such that the TTS model outputs synthetic speech in multiple different languages. However, even these multilingual TTS models are only compatible with a relatively small portion of all the languages spoken in the world. Particularly, a lack of sufficient training data in other languages, especially low-resource languages, inhibits TTS models from learning to generate synthetic speech in these other languages. As such, training a multilingual TTS model to generate synthetic speech in many different languages, even for low-resource languages, would further increase the use of TTS models.

### SUMMARY

One aspect of the disclosure provides a computer-implemented method that when executed on data processing hardware causes the data processing hardware to perform operations for massive multilingual speech-text joint semi-supervised learning for text-to-speech. The operations include receiving training data that includes a plurality of sets of text-to-speech (TTS) spoken utterances. Each set of the TTS spoken utterances is associated with a respective language from among a plurality of different languages that is different than the respective languages associated with each other set of the TTS spoken utterances and includes TTS utterances of synthetic speech spoken in the respective language. Each TTS utterance of synthetic speech includes a corresponding reference speech representation paired with a corresponding input text sequence. For each TTS utterance in each set of the TTS spoken utterances of the received training data, the operations include: generating a corresponding TTS encoded textual representation for the corresponding input text sequence using a text encoder, generating a corresponding speech encoding for the corresponding TTS utterance of synthetic speech using a speech encoder, generating a shared encoder output using a shared encoder configured to receive the corresponding TTS encoded textual representation or the corresponding speech encoding, and determining a reconstruction loss based on the predicted speech representation and the corresponding reference speech representation for the corresponding TTS utterance. The operations also include training a TTS model based on the reconstruction losses determined for the TTS utterances in each set of the TTS spoken training utterances to teach the TTS model to learn how to synthesize speech in each of the plurality of different languages.

Implementations of the disclosure may include one or more of the following optional features. In some implementations, for each TTS utterance in each set of the TTS spoken training utterances of the received training data, the operations further include obtaining a corresponding speaker embedding characterizing speaker characteristics of a corresponding speaker that spoke the TTS utterance of synthetic speech in the respective language and obtaining a corresponding variational embedding that specifies an intended prosody/style for the predicted speech representation generated for the corresponding TTS utterance of synthetic speech. In these implementations, the text encoder is configured to receive a concatenation of the corresponding input text sequence and the corresponding speaker embedding when generating the corresponding TTS encoded textual representation for the corresponding input text sequence and the speech decoder is conditioned on the corresponding variational embedding and the corresponding speaker embedding when generating the predicted speech representation for the corresponding TTS utterance of synthetic speech. In some examples, for each TTS utterance in each set of the TTS spoken training utterances of the received training data, the operations further include generating, using an automatic speech recognition (ASR) decoder configured to receive the shared encoder output, a sequence of speech recognition hypotheses representing a candidate transcription for the corresponding TTS utterance of synthetic speech and determining an ASR loss based on the sequence of speech recognition hypotheses and the corresponding input text sequence. Here, training the TTS model is further based on the ASR losses determined for the TTS utterances in each set of the TTS spoken training utterances.

The training data may further include a plurality of sets of automatic speech recognition (ASR) transcribed utterances each associated with a respective language that is different than the respective language associated with each other set of the ASR transcribed utterances and including ASR utterances of non-synthetic speech spoken in the respective language where each ASR utterance of non-synthetic speech is paired with a corresponding transcription and training the TTS model includes training the TTS model on the plurality of sets of ASR transcribed utterances. The speech decoder may include a recurrent neural network-transducer (RNN-T) architecture. In some implementations, the operations further include determining consistency losses between the speech encodings generated for the TTS utterances of synthetic speech using the speech encoder and the TTS encoded textual representations generated for the input text sequences. In these implementations, training the TTS model is further based on the consistency losses.

In some examples, the operations further include determining modality matching losses between the speech encodings generated for the TTS utterances of synthetic speech using the speech encoder and the TTS encoded textual representations generated for the input text sequences. In these examples, training the TTS model is further based on the modality matching losses. In some implementations, for each TTS utterance in each set of the TTS spoken training utterances of the received training data, the operations further include obtaining a sequence representation of the corresponding input text sequence concatenated with a variational embedding, using a duration model network to predict a duration of the input text sequence based on the sequence representation and upsample the sequence representation into a upsampled output specifying a number of frames, and determining a duration loss based on the predicted duration of the input text sequence and a ground-truth duration. In these implementations, generating the predicted speech representation for the corresponding TTS utterance of synthetic speech using the speech decoder configured to receive the shared encoder output is based on the upsampled output and training the TTS model further includes training the TTS model on the duration losses determined the TTS utterances in each set of the TTS spoken training utterances.

The operations may further include obtaining a masked language modeling (MLM) loss for the speech encodings generated for the TTS utterances of synthetic speech using the speech encoder and obtaining an aligned MLM loss for the TTS encoded textual representations generated for the input text sequences using the text encoder. Here, training the TTS model further includes training the TTS model on the MLM loss and the aligned MLM loss. In some examples, the training data further includes unspoken textual utterances in a respective plurality of different languages where each unspoken textual utterance is not paired with any corresponding spoken utterance of synthetic speech and, for each unspoken textual utterance, the operations further include generating a corresponding unspoken encoded textual representation for the corresponding unspoken textual utterance using the text encoder and obtaining an aligned masked language modeling (MLM) loss for the corresponding unspoken encoded textual representation generated for the corresponding unspoken textual utterance. In these examples, training the TTS model further includes training the TTS model based on the aligned MLM loss obtained for the unspoken encoded textual representation.

In some implementations, the training data further includes un-transcribed non-synthetic speech utterances in a respective plurality of different languages where each un-transcribed non-synthetic speech utterance is not paired with a corresponding transcription and, for each un-transcribed non-synthetic speech utterance, the operations further include generating a corresponding speech encoding for the corresponding un-transcribed non-synthetic speech utterance using the speech encoder and obtaining a masked language modeling (MLM) loss for the corresponding speech encoding generated for the corresponding un-transcribed non-synthetic speech utterance. In these implementations, training the TTS model further includes training the TTS model based on the MLM loss obtained for the corresponding speech encoding. The TTS model may include the text encoder and the speech decoder. In some examples, each corresponding input text sequence includes a sequence of graphemes, word-piece-model units, phonemes, or bytes.

Another aspect of the disclosure provides a system that includes data processing hardware and memory hardware storing instructions that when executed on the data processing hardware causes the data processing hardware to perform operations. The operations include receiving training data that includes a plurality of sets of text-to-speech (TTS) spoken utterances. Each set of the TTS spoken utterances is associated with a respective language from among a plurality of different languages that is different than the respective languages associated with each other set of the TTS spoken utterances and includes TTS utterances of synthetic speech spoken in the respective language. Each TTS utterance of synthetic speech includes a corresponding reference speech representation paired with a corresponding input text sequence. For each TTS utterance in each set of the TTS spoken utterances of the received training data, the operations include: generating a corresponding TTS encoded textual representation for the corresponding input text sequence using a text encoder, generating a corresponding speech encoding for the corresponding TTS utterance of synthetic speech using a speech encoder, generating a shared encoder output using a shared encoder configured to receive the corresponding TTS encoded textual representation or the corresponding speech encoding, and determining a reconstruction loss based on the predicted speech representation and the corresponding reference speech representation for the corresponding TTS utterance. The operations also include training a TTS model based on the reconstruction losses determined for the TTS utterances in each set of the TTS spoken training utterances to teach the TTS model to learn how to synthesize speech in each of the plurality of different languages.

Implementations of the disclosure may include one or more of the following optional features. In some implementations, for each TTS utterance in each set of the TTS spoken training utterances of the received training data, the operations further include obtaining a corresponding speaker embedding characterizing speaker characteristics of a corresponding speaker that spoke the TTS utterance of synthetic speech in the respective language and obtaining a corresponding variational embedding that specifies an intended prosody/style for the predicted speech representation generated for the corresponding TTS utterance of synthetic speech. In these implementations, the text encoder is configured to receive a concatenation of the corresponding input text sequence and the corresponding speaker embedding when generating the corresponding TTS encoded textual representation for the corresponding input text sequence and the speech decoder is conditioned on the corresponding variational embedding and the corresponding speaker embedding when generating the predicted speech representation for the corresponding TTS utterance of synthetic speech. In some examples, for each TTS utterance in each set of the TTS spoken training utterances of the received training data, the operations further include generating, using an automatic speech recognition (ASR) decoder configured to receive the shared encoder output, a sequence of speech recognition hypotheses representing a candidate transcription for the corresponding TTS utterance of synthetic speech and determining an ASR loss based on the sequence of speech recognition hypotheses and the corresponding input text sequence. Here, training the TTS model is further based on the ASR losses determined for the TTS utterances in each set of the TTS spoken training utterances.

The training data may further include a plurality of sets of automatic speech recognition (ASR) transcribed utterances each associated with a respective language that is different than the respective language associated with each other set of the ASR transcribed utterances and including ASR utterances of non-synthetic speech spoken in the respective language where each ASR utterance of non-synthetic speech is paired with a corresponding transcription and training the TTS model includes training the TTS model on the plurality of sets of ASR transcribed utterances. The speech decoder may include a recurrent neural network-transducer (RNN-T) architecture. In some implementations, the operations further include determining consistency losses between the speech encodings generated for the TTS utterances of synthetic speech using the speech encoder and the TTS encoded textual representations generated for the input text sequences. In these implementations, training the TTS model is further based on the consistency losses.

In some examples, the operations further include determining modality matching losses between the speech encodings generated for the TTS utterances of synthetic speech using the speech encoder and the TTS encoded textual representations generated for the input text sequences. In these examples, training the TTS model is further based on the modality matching losses. In some implementations, for each TTS utterance in each set of the TTS spoken training utterances of the received training data, the operations further include obtaining a sequence representation of the corresponding input text sequence concatenated with a variational embedding, using a duration model network to predict a duration of the input text sequence based on the sequence representation and upsample the sequence representation into a upsampled output specifying a number of frames, and determining a duration loss based on the predicted duration of the input text sequence and a ground-truth duration. In these implementations, generating the predicted speech representation for the corresponding TTS utterance of synthetic speech using the speech decoder configured to receive the shared encoder output is based on the upsampled output and training the TTS model further includes training the TTS model on the duration losses determined the TTS utterances in each set of the TTS spoken training utterances.

The operations may further include obtaining a masked language modeling (MLM) loss for the speech encodings generated for the TTS utterances of synthetic speech using the speech encoder and obtaining an aligned MLM loss for the TTS encoded textual representations generated for the input text sequences using the text encoder. Here, training the TTS model further includes training the TTS model on the MLM loss and the aligned MLM loss. In some examples, the training data further includes unspoken textual utterances in a respective plurality of different languages where each unspoken textual utterance is not paired with any corresponding spoken utterance of synthetic speech and, for each unspoken textual utterance, the operations further include generating a corresponding unspoken encoded textual representation for the corresponding unspoken textual utterance using the text encoder and obtaining an aligned masked language modeling (MLM) loss for the corresponding unspoken encoded textual representation generated for the corresponding unspoken textual utterance. In these examples, training the TTS model further includes training the TTS model based on the aligned MLM loss obtained for the unspoken encoded textual representation.

In some implementations, the training data further includes un-transcribed non-synthetic speech utterances in a respective plurality of different languages where each un-transcribed non-synthetic speech utterance is not paired with a corresponding transcription and, for each un-transcribed non-synthetic speech utterance, the operations further include generating a corresponding speech encoding for the corresponding un-transcribed non-synthetic speech utterance using the speech encoder and obtaining a masked language modeling (MLM) loss for the corresponding speech encoding generated for the corresponding un-transcribed non-synthetic speech utterance. In these implementations, training the TTS model further includes training the TTS model based on the MLM loss obtained for the corresponding speech encoding. The TTS model may include the text encoder and the speech decoder. In some examples, each corresponding input text sequence includes a sequence of graphemes, word-piece-model units, phonemes, or bytes.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example automatic speech recognition model.

FIGS. 3A-3C are schematic views of an example training process for training a text-to-speech (TTS) model using sets of ASR transcribed utterances.

FIG. 4 is a schematic view of an example alignment model used during the example training process.

FIGS. 5A-5C are schematic views of an example training process for training the TTS model using sets of TTS transcribed utterances.

FIG. 6 is a flowchart of an example arrangement of operations for a method of training a massive multilingual TTS model.

FIG. 7 is a schematic view of an example computing device that may be used to implement the systems and methods described herein.

Like reference symbols in the various drawings indicate like elements.

### DETAILED DESCRIPTION

Text-to-speech is the process generating synthetic speech based on input textual data. In some instances, TTS models are multilingual whereby the TTS model may receive a text input and generate synthetic speech corresponding to the text input in multiple different languages. Recently, TTS models have made significant advances in synthesizing human-like high-quality speech in multiple languages. Yet, even multilingual TTS models are only capable of generating synthetic speech in a few different languages. A major obstacle preventing TTS models from scaling to hundreds or even thousands of different languages is the difficulty in collecting a large quantity of high-quality paired training data in each of the different languages that is required to train the TTS model. In particular, low-resource languages have a very scarce amount of (or even zero) paired training data thereby further increasing the difficulty of scaling TTS models to these low-resource languages.

Accordingly, implementations herein are directed towards methods and systems for training a massive multilingual TTS model using speech-text joint semi-supervised learning. That is, a training process may receive training data that includes a plurality of sets of TTS spoken utterances. Each set of TTS spoken utterances is associated with a respective language different than the respective languages associated with each other set of TTS spoken utterances. Moreover, each set of TTS spoken utterances includes TTS utterances of synthetic speech in the respective language. Here, each TTS utterance of synthetic speech includes a corresponding reference speech representation paired with a corresponding input text sequence. For each TTS utterance in each set of the TTS spoken training utterances, the training process generates a corresponding TTS encoded textual representation using a text encoder, generates a corresponding speech encoding using a speech encoder, generates a shared encoder output based on the corresponding TTS encoded textual representation or the corresponding speech encoding using a shared encoder, generates a predicted speech representation based on the shared encoder output using a speech decoder, and determines a reconstruction loss based on the predicted speech representation and the corresponding reference speech representation.

Notably, the training process may employ one or more components (e.g., speech encoder and/or text encoder) of an automatic speech recognition (ASR) model to train the multilingual TTS model. In some examples, the ASR model and the TTS model share the same text encoder. In other examples, the ASR model and the TTS model each include a respective text encoder. Finally, the training process trains the multilingual TTS model based on the reconstruction losses determined for the TTS utterances in each set of the TTS spoken training utterances to teach the TTS model to learn how to synthesize speech in each of the plurality of different languages. More specifically, the training process may update parameters of the text encoder of the TTS model based on the reconstruction losses.

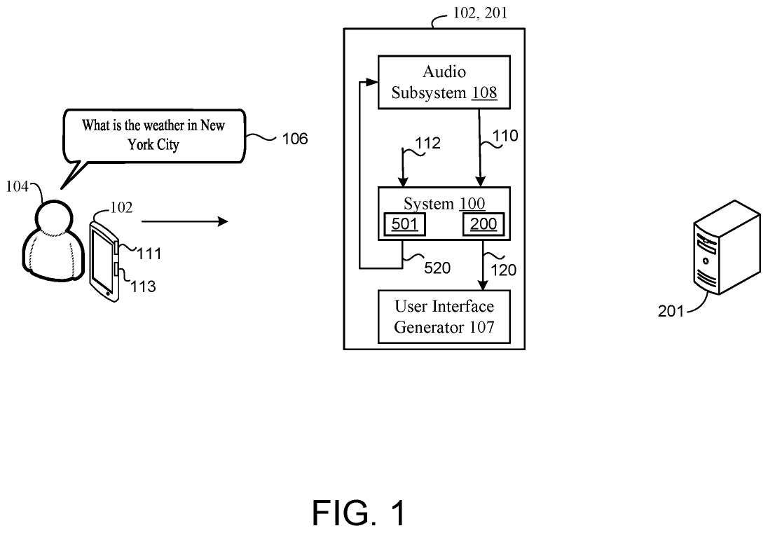

FIG. 1 illustrates an example system 100 implementing an automated speech recognition (ASR) model 200 and a text-to-speech (TTS) model 501 that resides on a user device 102 of a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, the TTS model 501 (e.g., executing on any combination of the user device 102 or the remote computing device 201) may convert the transcription into synthesized speech for audible output by the audio subsystem 108 or another device. For instance, the original utterance 106 may correspond to a message the user 104 is sending to a friend in which the transcription 120 is converted to synthesized speech for audible output to the friend to listen to the message conveyed in the original utterance 106.

The TTS model 501 receives, as input, a textual input 112 corresponding to a word or sequence of words and generates, as output, a corresponding speech representation 520 for the textual input. In particular, the TTS model 501 may generate textual encodings based on the textual input 112 and decode the textual encodings 520 to produce the speech representation 520. The user 104 may provide the textual input 112 via the user input to the user device 102. In some examples, the user 104 provides the textual input 112 directly by typing on a screen of the user device 102. In other examples, the user 104 may speak an utterance 106 such that the ASR model 200 generates the transcription 120 based on the utterance 106 which serves as the textual input 112. Without departing from the scope of the present disclosure, the textual input 112 may correspond to a response, notification, or other communication that a digital assistant is conveying to the user 104. The user 104 may also select a target embedding for use by the TTS model 501 in generating synthetic speech having speaker characteristics of a target speaker. Additionally or alternatively, the user 104 may further specify an intended prosody/style of the resulting synthetic speech. The audio subsystem 108 including a vocoder may receive the speech representation 520 and generate an audible output (e.g., via one or more speakers of the user device 102) of the textual input 112.

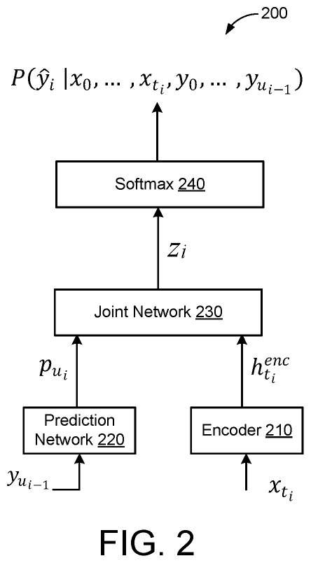

Referring to FIG. 2, in some examples, the ASR model 200 includes a Recurrent Neural Network-Transducer (RNN-T) model architecture which adheres to latency constraints associated with interactive applications. The use of the RNN-T model architecture is exemplary, and the ASR model 200 may include other architectures such as transformer-transducer and conformer-transducer model architectures among others. The RNN-T model architecture provides a small computation footprint and utilizes less memory requirements than conventional ASR architectures, making the RNN-T model architecture suitable for performing speech entirely on the user device 102 (e.g., no communication with a remote server is required). The RNN-T model architecture of the ASR model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder network 210 reads a sequence of d-dimensional feature vectors (e.g., acoustic frames 110 (FIG. 1)) x=x₁, x₂, . . . , x_{T}), where xₜ∈ [symbol] _{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{_{i−1}}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 24-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the ASR model 200 at the corresponding output step. In this manner, the RNN-T model architecture of the ASR model 200 does not make a conditional independence assumption, rather the prediction of each symbol is conditioned not only on the acoustics but also on the sequence of labels output so far. The ASR model 200 does assume an output symbol is independent of future acoustic frames 110, which allows the RNN-T model architecture of the ASR model 200 to be employed in a streaming fashion.

In some examples, the encoder network (i.e., audio encoder) 210 of the ASR model 200 includes a stack of self-attention layers/blocks, such as conformer blocks. Here, each conformer block includes a series of multi-headed self-attention, depth wise convolution and feed-forward layers. The prediction network 220 may have two 2,048-dimensional LSTM layers, each of which is also followed by 440-dimensional projection layer. Alternatively, the prediction network 220 may include a stack of transformer or conformer blocks, or an embedding look-up table in lieu of LSTM layers. Finally, the joint network 230 may also have 440 hidden units. The Softmax layer 240 may be composed of a unified word piece or grapheme set that is generated using all unique word pieces or graphemes in a plurality of training data sets.

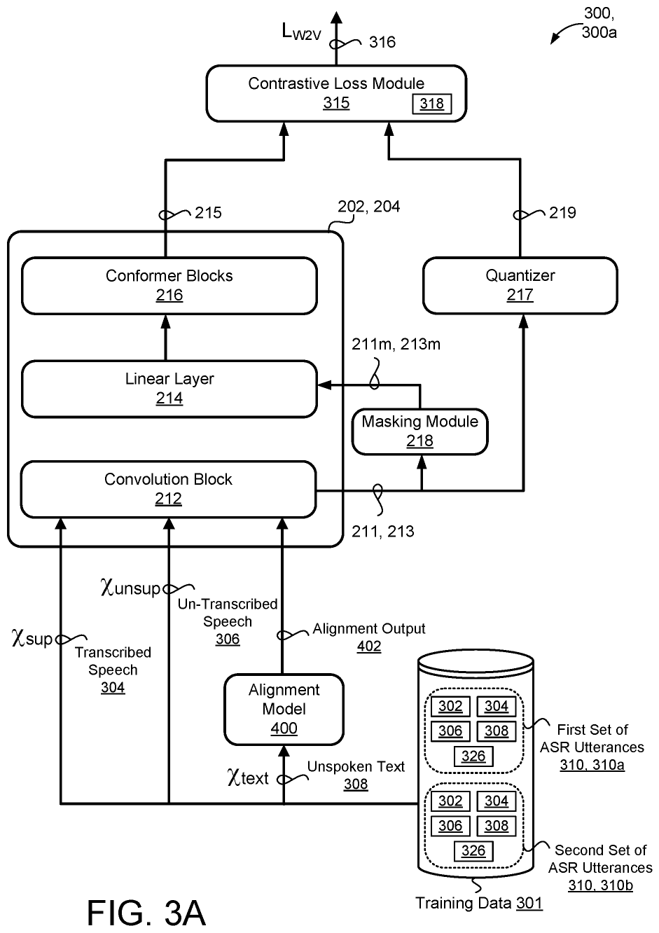

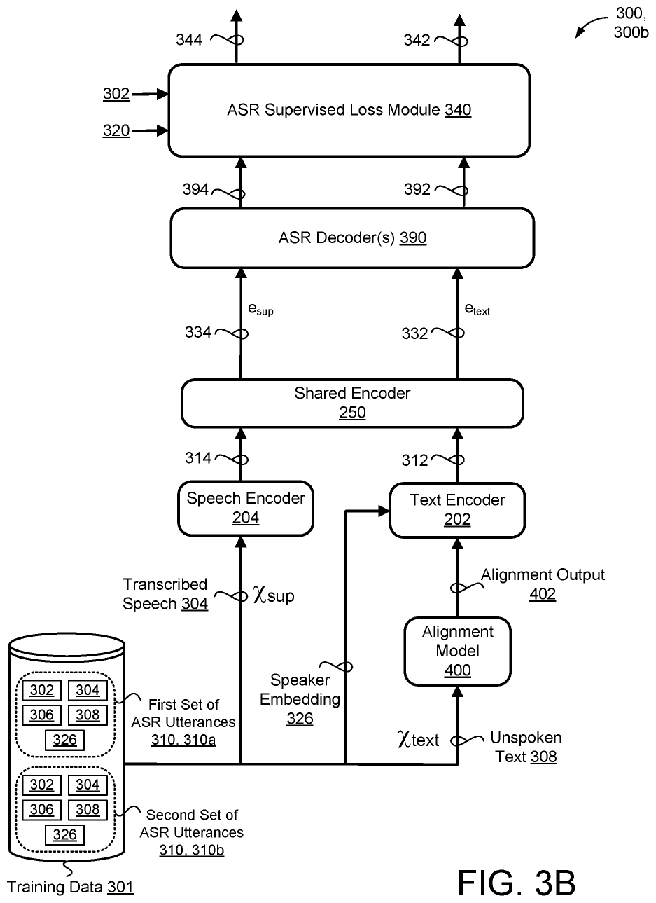

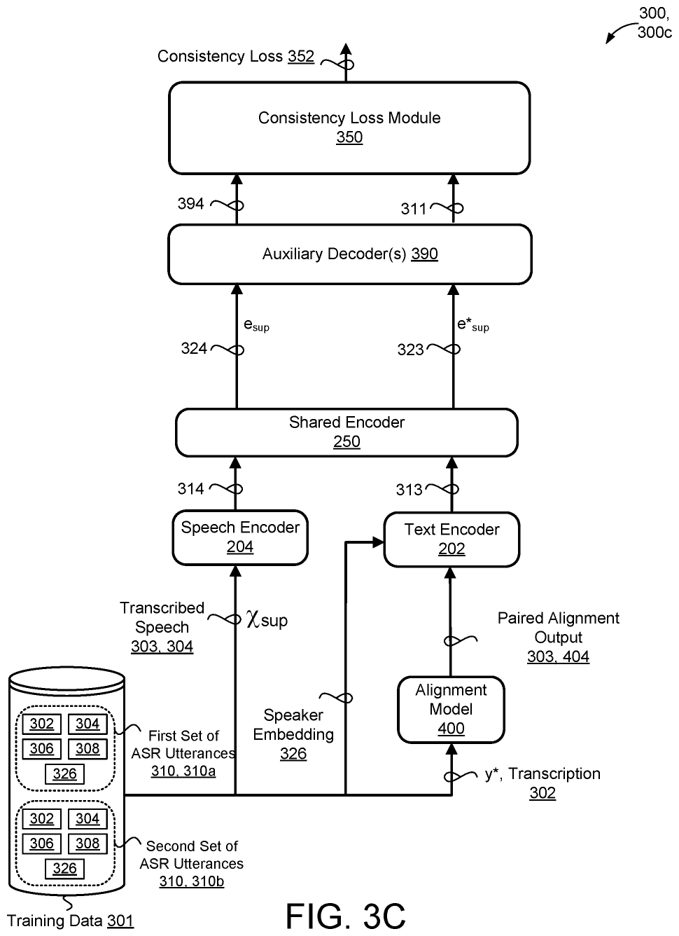

FIGS. 3A-3C illustrate an example training process 300 for training the TTS model 501 using sets of ASR transcribed utterances 310. In particular, the training process 300 may train a text encoder 202 of the TTS model 501. The TTS model 501 and the ASR model 200 may share the text encoder 204. As will become apparent, the training process 300 may train the TTS model 400 using training data 301 that includes a plurality of sets of ASR utterances 310. More specifically, each set of ASR utterances 310 of the plurality of sets of ASR utterances 310 includes a set of unspoken textual utterances (Xₜₑₓₜ) 308, a set of transcribed non-synthetic speech utterances (Xₛᵤₚ) 304, and/or un-transcribed non-synthetic speech utterances (Xᵤₙₛᵤₚ) 306. Each unspoken textual utterance 308 includes text-only data (i.e., unpaired data) such that each unspoken textual utterance 308 is not paired with any corresponding spoken audio representation (i.e., speech) of the utterance. The unspoken textual utterance 308 may include any sequence text chunks including words, word-pieces, phonemes, bytes, and/or graphemes. Each un-transcribed non-synthetic speech utterance 306 (also referred to as simply “un-transcribed speech utterance 306”) includes audio-only data (i.e., unpaired data) such that the un-transcribed speech utterance 306 is not paired with any corresponding transcription. On the other hand, each transcribed non-synthetic speech utterance 304 (also referred to as simply “transcribed speech utterance 304”) includes a corresponding transcription 302 paired with a corresponding non-synthetic speech representation of the corresponding transcribed speech utterance 304.

Moreover, each set of ASR utterances 310 is associated with a respective language that is different than the respective language associated with each other set of the ASR utterances 310 and includes ASR utterances of non-synthetic speech spoken in the respective language. For instance, in the example shown, the training data 301 includes a first set of ASR utterances 310, 310a including transcriptions 302, transcribed speech utterances 304, un-transcribed speech utterances 306, and unspoken textual utterances 308 each associated with a first respective language (e.g., English). Continuing with the example shown, the training data 301 also includes a second set of ASR utterances 310, 310b including transcriptions 302, transcribed speech utterances 304, un-transcribed speech utterances 306, and unspoken textual utterances 308 each associated with a second respective language (e.g., Chinese). The example shown includes two sets of ASR utterances 310 associated with two respective languages for the sake of clarity only, as it is understood that the training data 301 may include a number of sets of ASR utterances 310 associated with any number of languages.

For simplicity, the training process 300 includes a contrastive self-supervised loss part 300a (FIG. 3A), an ASR supervised loss part 300b (FIG. 3B), and a consistency regularization part 300c (FIG. 3C). The training process 300 trains the TTS model 501 on a total loss based on: contrastive losses (L_{w2v}) 316 derived using the contrastive self-supervised loss part 300a from the unspoken training text utterances (Xₜₑₓₜ) 308, a corpus of transcribed non-synthetic speech utterances (Xₛᵤₚ) 304, and un-transcribed non-synthetic speech utterances (Xᵤₙₛᵤₚ) 306; supervised losses (Lₐᵤₓ) 342, 344 derived using the ASR supervised loss part 300b from the unspoken training text utterances (Xₜₑₓₜ) 306 and the transcribed non-synthetic speech utterances (Xₛᵤₚ) 304; and consistency losses ( [symbol] _{cons}(θ)) 352 derived using the consistency regularization part 300c.

In some examples, the training process 300 employs an alignment model 400 that is configured to generate, at each of a plurality of output steps, alignment outputs (i.e., textual representation) 402 for a respective one of the plurality of unspoken training text utterances 308, the transcriptions 302, and/or the input text sequences 502. Accordingly, the alignment model 400 may generate a corresponding alignment output 402 for each one of the unspoken textual utterances 308, the transcriptions 302, and/or the input text sequences 502. Thereafter, the training process 300 trains the TTS model 501 using the generated alignment outputs 402.

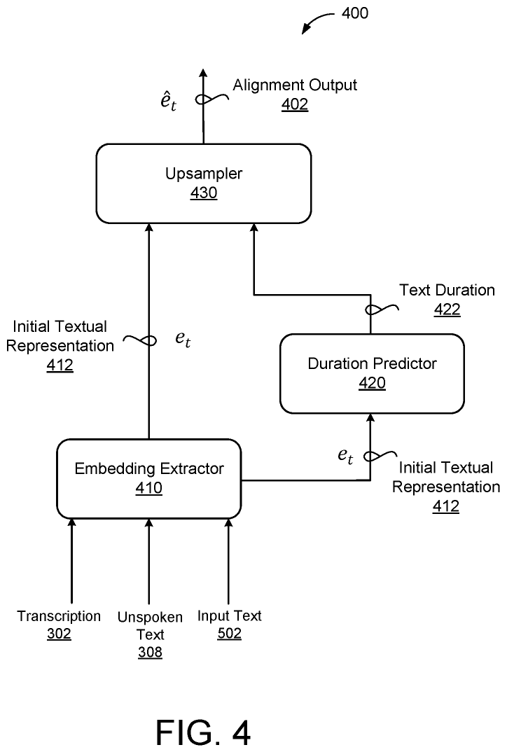

Referring now to FIG. 4, in some examples, the alignment model 400 includes an embedding extractor 410, duration predictor 420, and an upsampler 430. The embedding extractor 410 receives a respective one of the unspoken textual utterances 308, transcriptions 302, and/or input text sequences 502. Here, the unspoken textual utterances 308, transcriptions 302, and input text sequences 502 may each include a sequence of text chunks including words, word-pieces, phonemes, bytes, and/or graphemes. As such, the embedding extractor 410 extracts a corresponding initial textual representation (eₜ) 412 for the respective one of the unspoken textual utterances 308, transcriptions 302, and/or input text sequences 502. For example, the embedding extractor 410 may receive a respective input text sequence 502 and extract the initial textual representation 412 from the respective input text sequence 502. The initial textual representation 412 includes embedding lexical information from the sequence of text chunks. The duration predictor 420 receives the initial textual representation 412 from the embedding extractor 410 and predicts a corresponding text chunk duration (i.e., word, word-piece, phoneme, and/or grapheme duration) 422. The text chunk duration 422 indicates a duration the corresponding text chunk would be spoken if a human (or text-to-speech system) spoke the unspoken textual utterance 308. For example, the input text sequence 502 may include a sequence of phonemes and the duration predictor 420 predicts a phoneme duration 422 for each phoneme in the sequence of phonemes. In this example, the duration predictor 420 predicts the phoneme duration 422 by predicting a probability of non-zero duration for each phoneme and predicting a probability of continuous phoneme duration for each phoneme. As the sequence of phonemes includes regular phonemes, silences between word boundaries, and punctuation marks, only the regular phonemes are associated with non-zero duration while the silences and punctuation marks are generally associated with the continuous phoneme duration. Accordingly, the duration predictor 420 may use a sigmoid activation following a first one of two independent activations to predict the probability of non-zero duration and use a soft plus activation following a second one of the two independent projections to predict the continuous text chunk duration 422 for each text chunk. The duration predictor 420 determines, for each text chunk, whether the probability of non-zero duration is less than a threshold value, and when the probability of non-zero duration is less than the threshold value, a multiplier may zero-out the continuous text chunk duration 422 predicted by the softplus activation for the corresponding text chunk. Otherwise, when the probability of non-zero duration is not less than the threshold value, the predicted text chunk duration 422 may be set equal to the continuous phoneme duration predicted by the softplus activation.

The upsampler 430 receives each corresponding initial textual representation 412 output by the embedding extractor 410 and the corresponding predicted text chunk duration 422, and generates an alignment output (êₜ) 402 that has a number of frames by upsampling the initial textual representation 412 using the corresponding predicted text chunk duration 422. In some examples, the alignment model 400 sends the alignment output 402 to the text encoder 202. In other examples (not shown), the alignment model 400 sends the alignment output 402 to a shared encoder 250 (e.g., bypassing the text encoder 202) of the encoder 210. In these other examples, the alignment output 402 serves as the encoded textual representation 312 such that the shared encoder 250 may receive the alignment output 402 directly from the alignment model. In some additional examples, paired training data is available and the upsampler 430 generates the alignment output 402 as follows.

êₜ=σ_{Refiner} (Resample(eₜ,Align_{RNN-T}(e_{S},t))) (1)

Here, the upsampler includes resampler and refiner layers that align the initial textual embedding 412 to align with a corresponding encoded audio representation 314 directly. In other examples, paired training data is not available and the upsampler 430 generates the alignment output 402 as follows.

êₜ=θ_{Refiner} (Resample(eₜ, θ_{duration}(eₜ))) (2)

In particular, the number of frames of the alignment output 402 indicates a predicted speech duration of the respective one of the unspoken textual utterances 308, transcriptions 302, or input text sequences 502. Stated differently, the number of frames of the alignment output 402 maps (i.e., aligns) the sequence of text chunks of the text input to speech frames. Here, the upsampler 430 includes resampler and refiner layers that replicate the initial textual embedding 412 to match the predicted text chunk duration 422 (i.e., speech duration). As such, the alignment output 402 includes a textual representation of the text input (e.g., the unspoken textual utterances 308, transcriptions 302, and/or input text sequences 502) having a timing component that aligns with how a human would speak the text input.

Notably, in most instances, a TTS system (i.e., an auxiliary TTS system) generates an audible output to give text input the timing component of human speech such that a training process may use the audible output (i.e., synthetic speech) to train the encoder 210. Thus, since the alignment model 400 generates the alignment output 402 that maps the sequence of text chunks to speech frames directly, the training process 300 does not require speech synthesis of speech to generate the alignment outputs 402. That is, the alignment model 400 does not convert the input text into synthetic speech.

Referring now specifically to FIG. 3A, in some implementations, the encoder 210 includes a speech encoder 204 and the text encoder 202, described in more detail with reference to FIGS. 3B and 3C. In the example shown, the speech encoder 204 processes audio input (e.g., transcribed speech utterance 304 and un-transcribed speech utterances 306) and the text encoder 206 processes text input (e.g., unspoken text 308). Each of the speech encoder 204 and the text encoder 202 includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. Each of the speech encoder 204 and the text encoder 202 may naturally be split into a feature encoder, including a convolution sub sampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed non-synthetic speech utterance 304 and each un-transcribed non-synthetic speech utterance 306, and generates, as output, for each of a plurality of output steps, an encoded audio feature 211 that corresponds to a respective one of the transcribed non-synthetic speech utterances 304 or a respective one of the un-transcribed non-synthetic speech utterances 306. The convolution subsampling block 212 may receive, as input, each alignment output 402 and generate, as output, for each of the plurality of output steps, an encoded textual feature 213 that corresponds to a respective one of the alignment outputs 402.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. Thereafter, a contrastive loss module 315 derives a contrastive loss (L_{w2v}) 316 between the contrastive context vectors 215 at the masked positions and the target context vectors 219 as follows.

$${ℒ}_{w 2 v} = - log \frac{exp ( sim ( {c}_{t} , {q}_{t} ) / k )}{{Σ}_{\tilde{q} ∼ {Q}_{t}} exp ( sim ( {c}_{t} , \tilde{q} ) / k )} \qquad ( 3 )$$

where cₜ is contrastive context vector 215 centered over a masked time step t and qₜ represents a target context vector 219 at the time step tin a set of K+1 candidate target context vectors 219 which includes qₜ and K distractors. Distractors may be uniformly sampled from other masked time steps of the same utterance.

The contrastive loss 316 is optimized between the contrastive context vectors 215 at the masked positions and the target context vectors 219. After the encoder 210 converges on the un-transcribed non-synthetic speech utterances 306, the training procedure is repeated on both the alignment outputs 402 corresponding to the unspoken textual utterance 308 and the transcribed non-synthetic speech utterances 304. Thus, the contrastive loss (L_{w2v}) is optimized for both real/human (non-synthetic) and the unspoken textual utterances 308 represented by alignment outputs 402, with additional auxiliary losses on the transcribed non-synthetic speech utterances 304 and the alignment outputs 402 as described in greater detail below with reference to FIG. 3B. Accordingly, the contrastive part 300a of the training process 300 trains the speech encoder 204 and the text encoder 202 on the derived contrastive loss 316 applied on the corresponding encoded features 211, 213 associated with each alignment output 402, each transcribed non-synthetic speech utterance 304, and each un-transcribed non-synthetic speech utterance 306 provided as input to the encoder 210. Training the encoder 210 may include updating parameters of the encoder 210 based on the contrastive losses 316. In some implementations, the contrastive loss module 315 determines a masked language modeling (MLM) loss 318 for the speech input (e.g., transcribed speech utterance 304 and un-transcribed speech utterances 306) by comparing the contrastive context vector 215 generated from masked encoded features to contrastive context vectors 215 generated from corresponding unmasked encoded features. Thus, the MLM loss 318 compares the encodings generated for masked and unmasked encoded features.

Referring now to FIG. 3B, the ASR supervised loss part 300b of the training process 300 is configured to inject lexical information into the text encoder 204 of the TTS model 501 during pre-training based on supervised loss terms 342, 344 derived from the transcribed non-synthetic speech utterances 304 and the alignment outputs 402 corresponding to unspoken textual utterances 308 output by the alignment model 400. Notably, the ASR supervised loss part 300b leverages one or more ASR decoders 390 for generating the supervised loss terms (i.e., ASR loss) 342, 344. The ASR decoders 390 may include Connectionist Temporal Classification (CTC) decoders, Listen Attend Spell (LAS) decoders, or RNN-T decoders. These ASR decoders 390 may include at least one of a phoneme decoder configured to decode a sequence of phonemes or a wordpiece decoder configured to decode a sequence of word pieces. The ASR decoders 390 could also include a grapheme decoder configured to decode a sequence of graphemes.

During the ASR supervised loss part 300b, the text encoder 202 is configured to receive alignment outputs 402 (i.e., text embeddings) from the alignment model 400 and the speech encoder 204 is configured to receive transcribed non-synthetic speech utterances 304. That is, the text encoder 202 generates encoded textual representations 312 for alignment outputs 402 (e.g., corresponding to an unspoken textual utterance 308) and the speech encoder 204 of the encoder 210 generates encoded audio representations 314 for speech inputs (i.e., transcribed non-synthetic speech utterances 304). Here, the encoded textual representations 312 and the encoded audio representations 314 may not both be compatible with the ASR decoders 390. In some examples, the text encoder 202 obtains a corresponding speaker embedding 326 that characterizes speaker characteristics of a corresponding speaker that spoke the ASR utterance in the respective language and generates the corresponding encoded textual representation 312 based on a concatenation of the corresponding alignment output 402 and the corresponding speaker embedding 326.

Thus, the ASR supervised loss part 300b may employ a shared encoder 250 that receives the encoded textual representations 312 as input, and generates a first encoded shared representation 322 (eₜₑₓₜ) as output. Similarly to the text encoder 202, the TTS model 501 and the ASR model 200 may share the shared encoder 250. Moreover, the shared encoder 250 receives the encoded audio representations 314 as input, and generates a second encoded shared representation (eₛᵤₚ) 324 as output. Accordingly, the shared encoder 250 generates the first and second encoded shared representations 322, 324 into a shared latent representation space compatible with the ASR decoder 390.

In particular, the shared encoder 250 receives, as input, each encoded textual representation 312 that corresponds to the alignment output 402 generated from the unspoken textual utterance 308 and generates, as output, for each of a plurality of time steps, the first encoded shared representation (eₜₑₓₜ) 322 that corresponds to the alignment output 402 at the corresponding output step. The ASR decoder 390 including the phoneme decoder or the wordpiece decoder receives, as input, each first encoded shared representation 332 output from the shared encoder 250 and generates, as output, a first probability distribution 392 over possible speech recognition hypotheses for the corresponding alignment output 402 at the corresponding output step. In some examples, the first probability distribution 392 over possible speech recognition hypotheses includes one of possible phoneme labels, possible word piece labels, or possible grapheme labels. Thereafter, an ASR supervised loss module 340 may determine an alignment output loss term 342 based on the first probability distribution 392 over possible speech recognition hypotheses for the alignment output 402 corresponding to the unspoken textual utterance 308. Here, the corresponding unspoken textual utterance 308 in which the alignment output 402 is generated from also serves as a ground-truth transcription 302. Since the alignment output 402 may be masked, the alignment output loss term 342 also serves as an aligned MLM loss. The ASR supervised loss part 300b may train the text encoder 202 and/or speech encoder 204 on the alignment output loss term 342 by updating parameters of the text encoder 202 and/or the speech encoder 204 based on the alignment output loss term 342.

Similarly, during the ASR supervised loss part 300b, the shared encoder 250 receives, as input, each transcribed encoded audio representation 314 that corresponds to the non-synthetic speech utterance 304 and generates, as output, for each of a plurality of time steps, a second encoded shared representation (eₛᵤₚ) 334 that corresponds to the transcribed non-synthetic speech utterance 304 at the corresponding time step. The ASR decoder 390 including the phoneme decoder or the wordpiece decoder receives, as input, each second encoded shared representation 334 output from the shared encoder 250 and generates, as output, a second probability distribution 394 over possible non-synthetic speech recognition hypotheses for the corresponding transcribed non-synthetic speech utterance 304 at the corresponding time step. In some examples, the second probability distribution 394 over possible non-synthetic speech recognition hypotheses includes the one of possible phoneme labels, the possible word piece labels, or the possible grapheme labels. Thereafter, the ASR supervised loss module 340 may determine a non-synthetic speech loss term 344 based on the second probability distribution 394 over possible non-synthetic speech recognition hypotheses and the corresponding transcription 302 paired with the transcribed non-synthetic speech utterance 304. Here, the corresponding transcription 302 serves as a ground-truth transcription and may include a sequence of target phonemes, target word pieces, and/or target graphemes. The ASR supervised loss part 300b may train the text encoder 202 and/or speech encode 204 on the non-synthetic speech loss term 344 by updating parameters of the text encore 202 and/or speech encoder 204 based on the non-synthetic speech loss term 344.

The un-transcribed non-synthetic speech utterances 306 and the unspoken textual utterances 308 each correspond to “unpaired” training data whereby the contrastive loss (L_{w2v}) derived from the unspoken textual utterances (Xₜₑₓₜ) 308 may be combined with the supervised loss [symbol] ₐᵤₓ associated with the alignment output loss term 342 to obtain an unspoken textual loss function, ≈ₜₑₓₜ, as follows.

[symbol]

ₜₑₓₜ [symbol] _{w2v}(x|θₑ)+ [symbol] ₐᵤₓ(y|x, θₑ, θ_{d}) (4)

Likewise, the contrastive loss (L_{w2v}) 316 derived from the un-transcribed non-synthetic speech utterances (Xᵤₙₛᵤₚ) 306 may be used to express an unsupervised speech loss function, [symbol] _{unsup_speech}, as follows.

[symbol]

_{unsup_speech}= [symbol] _{w2v}(x*|θₑ) (5)

During training of the text encoder 202 and the speech encoder 204, the alignment outputs 402 and the un-transcribed non-synthetic utterances 306 may be separated or mixed within each batch. In order to force the text encoder 202 to learn representations that are effective for both alignment outputs 402 corresponding to unspoken textual utterances 308 and non-synthetic (human/real) speech, the loss mask σ is applied when combining the loss functions [symbol] ₜₑₓₜ and of Equations. 5 and 6 to obtain an unpaired data loss function, [symbol] _{unpaired}, as follows.

[symbol]

_{unpaired}=σ [symbol] ₜₑₓₜ+(1−σ) [symbol] _{speech} (6)

The transcribed non-synthetic speech utterances 304 corresponds to “paired” and “supervised” training data whereby the derived contrastive loss L_{w2v} and the derived supervised loss [symbol] ₐᵤₓ associated with the non-synthetic speech loss term 344 may be combined to obtain a paired data loss function, [symbol] _{paired}, as follows.

[symbol]

_{paired}= [symbol] _{w2v}(x|θₑ)+ [symbol] ₐᵤₓ(y|x, θₑ, θ_{d}) (7)

Referring to FIG. 3C, the consistency regularization part (i.e., modality matching part) 300c of the training process 300 is configured to promote the text encoder 202 and the speech encoder 204 to learn consistent predictions between non-synthetic speech (e.g., real/human speech) and alignment outputs 402 corresponding to unspoken textual utterances 308 by generating a consistent loss term ( [symbol] _{cons}(θ)) 352 between training utterance pairs 303 that each include a corresponding one of the transcribed non-synthetic speech utterances (Xₛᵤₚ) 304 and a paired alignment output 404 of the same utterance as the corresponding transcribed non-synthetic speech utterance 304. As such, the non-synthetic speech utterance 304 and the paired alignment output 404 of each training utterance pair 303 is associated with a same ground-truth transcription. In short, the consistent loss term 352 between the transcribed non-synthetic speech utterance 304 and paired alignment output 404 of the same training utterance provides an unsupervised training aspect by encouraging the encoder 210 to behave consistently regardless of whether the training utterance belongs to non-synthetic speech (i.e., speech training data) or the alignment output (i.e., text training data) and independent of supervised loss terms between the ground-truth transcription 302 and each of: non-synthetic speech recognition hypotheses output by the auxiliary decoder 390; and speech recognition hypothesis output by the auxiliary decoder 390.

Similar to the alignment outputs 402 generated from the unspoken textual utterances 308 in FIG. 3B, the alignment model 400 may generate each paired alignment output 404 using the corresponding transcription 302 that is paired with the transcribed non-synthetic speech utterance 304. Here, the non-synthetic speech representation 304 is associated with paired alignment output 404 generated by the alignment model 400 mapping the unspoken textual utterance 308 into speech frames.

During the consistency regularization part 300c, the text encoder 202 receives,

as input, each paired alignment output 404 and generates, as output, for each of a plurality of time steps, an encoded textual representation 313 that corresponds to the paired alignment output 404 at the corresponding output step. In some examples, the text encoder 202 obtains a corresponding speaker embedding 326 that characterizes speaker characteristics of a corresponding speaker that spoke the ASR utterance in the respective language and generates the corresponding encoded textual representation 312 based on a concatenation of the corresponding alignment output 402 and the corresponding speaker embedding 326. The shared encoder 250 receives, as input, the encoded textual representation 313 and generates, as output, a first encoded shared representation (e*ₛᵤₚ) 323. The auxiliary decoder 390 including the phoneme decoder or the wordpiece decoder receives, as input, each first encoded shared representation 323 output from the shared encoder 250 and generates, as output, a first probability distribution 311 over possible speech recognition hypotheses for the corresponding paired alignment output 404 at the corresponding output step. In some examples, the first probability distribution 311 over possible speech recognition hypotheses includes one of possible phoneme labels or possible word piece labels.

Similarly, the speech encoder 204 receives, as input, each transcribed non-synthetic speech utterance 304 as a sequence of features/vectors (e.g., mel-frequency spectrograms such as the acoustic frames 110 of FIG. 1) and generates, as output, for each of a plurality of time steps, a encoded audio representation 314 that corresponds to the transcribed non-synthetic speech utterance 304 at the corresponding output step. The shared encoder 250 receives, as input, the encoded audio representation 314 and generates, as output, a second encoded shared representation (eₛᵤₚ) 324. The auxiliary decoder 390 including the phoneme decoder or the wordpiece decoder receives, as input, each second encoded shared representation 324 output from the shared encoder 250 and generates, as output, a second probability distribution 394 over possible non-synthetic speech recognition hypotheses for the corresponding transcribed non-synthetic speech utterance 304 at the corresponding time step. In some examples, the second probability distribution 394 over possible non-synthetic speech recognition hypotheses includes the one of the possible phoneme labels or the possible word piece labels.

With continued reference to FIG. 3C, the consistency regularization part 300c of the training process 300 further determines, at each of the plurality of output steps for each training utterance pair 301, the consistent loss term ( [symbol] _{cons}(θ)) 352 for the corresponding training utterance pair 301 based on the first probability distribution 311 over possible speech recognition hypotheses and the second probability distribution 394 over possible non-synthetic speech recognition hypotheses. For instance, the training process 300 may employ a consistency loss term module 350 configured to receive, at each time step, the corresponding non-synthetic speech and speech recognition results 311, 394 output by the auxiliary decoder 390, and determine the consistency loss term 352 for the corresponding training utterance pair 301 at the time step.

In some examples, the consistency regularization part 300c of the training process 300 determines the consistent loss term 352 based on a Kullback-Leibler divergence (D_{KL}) between the first probability distribution 311 over possible speech recognition hypotheses and the second probability distribution 394 over possible non-synthetic speech recognition hypotheses. The consistent loss term 352 based on D_{KL} may be expressed by the following equation.

[symbol]

_{cons}(θ)= [symbol] _{KL}(p_{\tilde{θ}}(y|x)∥p_{θ}(y|\hat{x})) (8)

Here, the consistent loss term 352 determined for the training utterance pair 301 at each time step provides an “unsupervised” loss term that is independent of the accuracy of the auxiliary decoder 390 (e.g., independent of the supervised loss terms 342, 344 of FIG. 3B), and thus, may be employed to update parameters of the encoder 210 for promoting consistency between non-synthetic speech representations and alignment outputs of the same utterances. In batch training, the consistent loss term 352 may correspond to an average loss term obtained for the batch. In other words, the consistent loss term 352 permits the text encoder 202 and the speech encoder 204 to learn to behave the same, e.g., make consistent encoded representation predictions on both non-synthetic speech (e.g., real/human speech) and alignment outputs of a same training utterance, regardless of whether the training utterance belongs to non-synthetic speech or alignment outputs.

Lastly, the training process 300 may combine the unpaired data loss function ( [symbol] _{unpaired}), the paired data loss function ( [symbol] _{paired}), and the consistent loss term ( [symbol] _{cons}) to obtain an overall loss term, [symbol] ₜₜₛ₄ₚᵣₑₜᵣₐᵢₙ₂, that may be expressed as follows.

[symbol]

ₜₜₛ₄ₚᵣₑₜᵣₐᵢₙ₂= [symbol] _{unpaired}+λ₁ [symbol] paired+λ₂ [symbol] _{cons} (9)

where λ₁ may be equal to 1.0 and λ₂ is equal to 0.1. The training process 300 may pre-train the audio encoder speech encoder 204 and the text encoder 202 using the overall loss term, [symbol] ₜₜₛ₄ₚᵣₑₜᵣₐᵢₙ₂, by updating parameters of the speech encoder 204 and the text encoder 202 to effectively teach the speech encoder 204 and the text encoder 202 to learn shared representations between speech and text. After pre-training the speech encoder 204 and the text encoder 202, the training process 300 may fine-tune the pre-trained speech encoder 204 and the text encoder 202 on transcribed speech utterances that may include supervised training samples of both alignment outputs corresponding to unspoken textual utterance 308 and non-synthetic (e.g., human speech).

In some implementations, the training process 300 for pre-training the speech encoder 204 and the text encoder 202 applies encoder consistency regularization. Unlike decoder consistency regularization applied to auxiliary decoder(s) during the consistency regularization part 300c that requires hypothesized labels (e.g., transcripts 302 and unspoken textual utterances 308), encoder consistency regularization does not require hypothesized labels and therefore has the advantage being allowed to be applied to all the training data 304, 306, 308. Encoder consistency regularization may be applied via Hierarchical Contrastive consistency Regularization (HCCR) techniques where encoder activations e, e* from original/non-augmented and augmented speech are projected through an auxiliary network to generate z and z*. Thereafter, positive and negative pairs are constructive and a contrastive loss l_{t,z,z*} is calculated as follows.

$${l}_{t , z , {z}^{*}} = - log \frac{exp ( sim ( {z}_{t}^{*} , {z}_{t} ) / τ )}{{\sum }_{k = 1}^{T} exp ( sim ( {z}_{t}^{*} , {z}_{k} ) / τ )} \qquad ( 10 )$$

Specific to HCCR, a Convolutional Neural Network (CNN) projection network may calculate projections over increasing length segments of encoder activations e (30, 50, 120 ms) to yield 3 views (V) and draw negative examples from the same utterance for short segments, and from other utterances in the batches with 120 ms segments. Accordingly, an HCCR loss may be calculated over the transcribed non-synthetic speech utterances 304 (paired speech), the un-transcribed non-synthetic speech utterances 306 (unpaired speech), and the alignment outputs 402 generated from the unspoken textual utterances 308 as follows.

$${ℒ}_{enc \_ cons} = {\sum }_{v = 1}^{V} {\sum }_{t = 1}^{{T}^{( v )}} {l}_{t , {z}^{* ( v )} , {z}^{( v )}} \qquad ( 11 )$$

The HCCR loss calculated by Equation 11 may be added to Equation 9 with a coefficient of 1e-3 as part of the overall loss term, [symbol] ₜₜₛ₄ₚᵣₑₜᵣₐᵢₙ₂, for use in pre-training the speech encoder 204 and the text encoder 202.

In short, the training process 300 trains the TTS model 501 using the sets of ASR utterances 310 by training the speech decoder 204, the text encoder 202, and/or the shared encoder 250 based on any of the losses derived by the training process 300. Even though the speech decoder 204 and the shared encoder 240 may not be employed by the TTS model 501 during inference, the training process 300 trains these components to learn better shared representations between speech and text thereby further training the TTS model 501 (e.g., text encoder 202 of the TTS model 501) to generate encodings that accurately represent human speech.

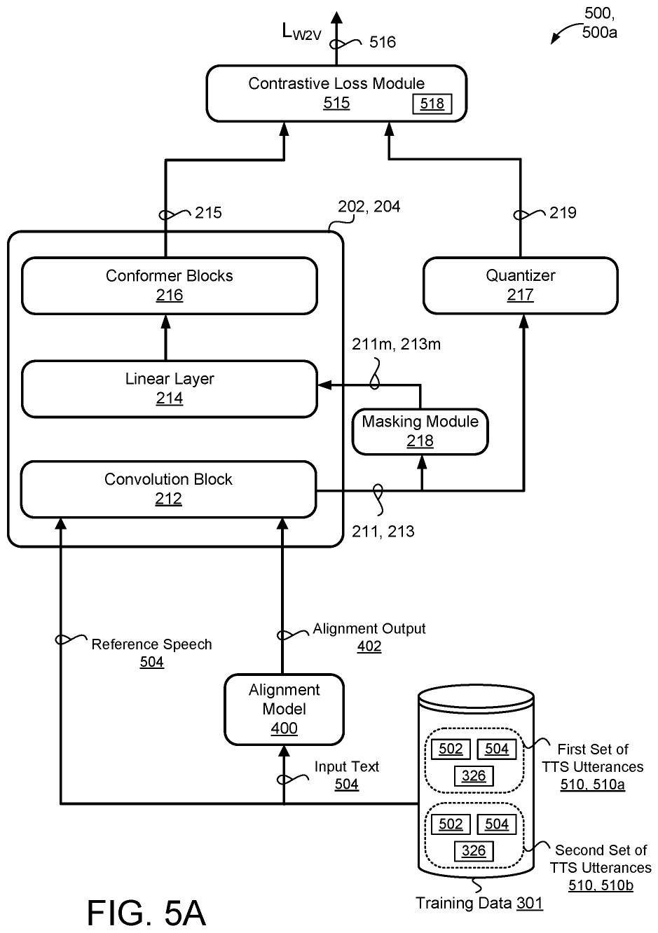

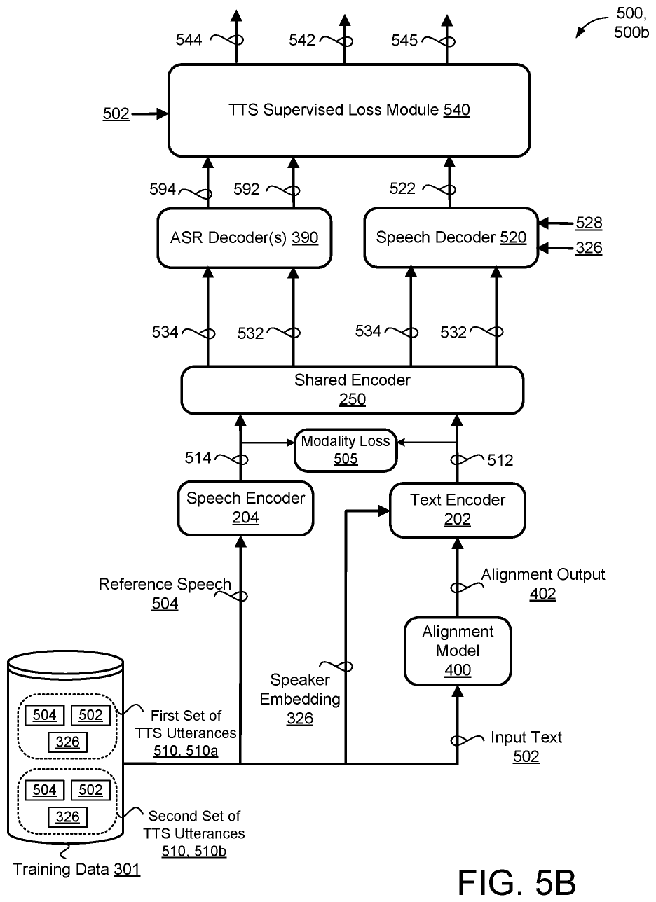

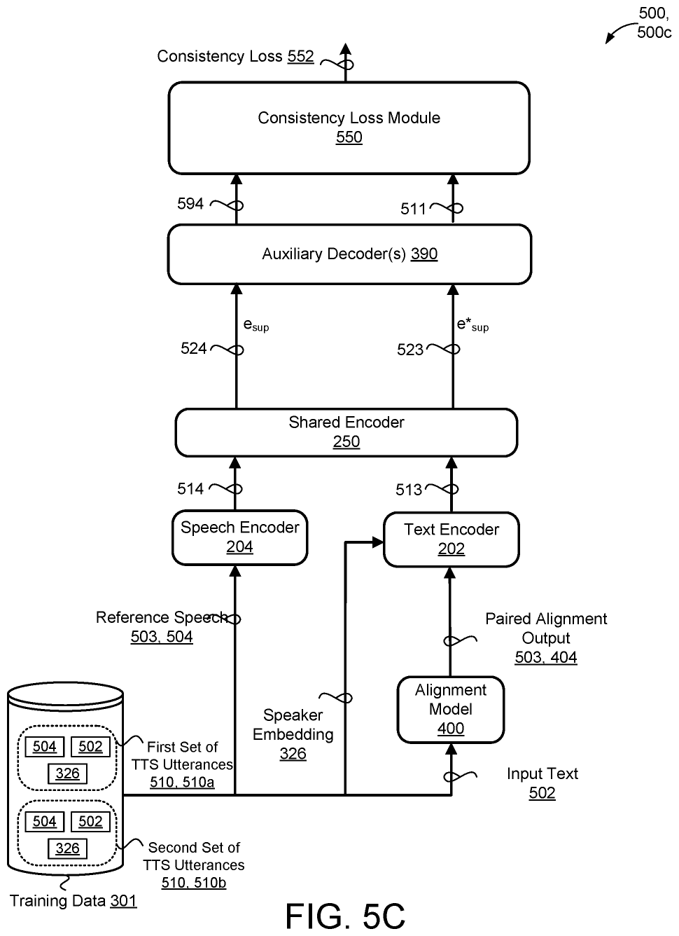

FIGS. 5A-5C illustrate an example training process 500 for training the TTS model 501 using sets of TTS spoken utterances 510. Similar to the training process 300 (FIGS. 3A-3C), the training process 500 trains the text encoder 202 of the TTS model 501, however, the training process 500 also trains a speech decoder 520 of the TTS model 501. As will become apparent, the training process 500 may train the TTS model 501 using the training data 301 that also includes a plurality of sets of TTS spoken utterances 510. In contrast to the ASR utterance 310, the TTS spoken utterances 510 may include synthetic speech while the ASR utterance 510 include non-synthetic or human speech.

Each set of TTS spoken utterances 510 of the plurality of sets of TTS spoken utterances 510 includes TTS utterances of synthetic speech spoken in a respective language. In particular, each TTS utterance of non-synthetic speech includes a corresponding reference speech representation 504 paired with a corresponding input text sequence 502. Here, the reference speech representation 504 includes audio data paired with the corresponding input text sequence 502 thereby forming labeled training data for training the TTS model 501. The reference speech representation 504 and the TTS utterance 504 may be used interchangeably. In some examples, the reference speech representations 504 and the input text sequences 502 are the same as the transcribed speech utterances 304 and the transcriptions 302 (FIGS. 3A-3C). In other examples, the reference speech representations 504 and the input text sequences 502 are different from the transcribed speech utterances 304 and the transcriptions 302. Each TTS utterance of non-synthetic speech may include the speaker embedding 326 characterizing speaker characteristics of a corresponding speaker that spoke the TTS utterance in the respective language.

Moreover, each set of TTS spoken utterances 510 is associated with a

respective language from among a plurality of different languages that is different than the respective language associated with each other set of TTS spoken utterances 510. For instance, in the example shown, the training data 301 includes a first set of TTS spoken utterances 510, 510a including input text sequences 502 and reference speech representations 504 each associated with the first respective language (e.g., English) and a second set of TTS spoken utterances 510, 510b input text sequences 502 and reference speech representations 504 each associated with the second respective language (e.g., Chinese). The example shown includes two sets of TTS spoken utterances 510 associated with two respective languages for the sake of clarity only, as it is understood that the training data 301 may include a number of sets of TTS spoken utterances 510 associated with any number of languages. Each set of TTS spoken utterances 510 may include the corresponding speaker embedding 326.

For simplicity, the training process 501 includes a contrastive self-supervised loss part 500a (FIG. 5A), a TTS supervised loss part 500b (FIG. 5B), a consistency regularization part 500c (FIG. 5C). The training process 500 trains the TTS model 501 on a total loss based on: contrastive losses (L_{w2v}) 516 derived using the contrastive self-supervised loss part 500a from the reference speech representations 504 and the input text sequences 502; supervised losses (Lₐᵤₓ) 542, 544 and a reconstruction loss 545 derived using the TTS supervised loss part 500b derived from the reference speech representations 504 and the input text sequences 502; and consistency losses ( [symbol] _{cons}(θ)) 552 derived using the consistency regularization part 500c. As discussed above, the training process 500 may employ the alignment model 400 to generate, at each of the plurality of output steps, alignment outputs 402 for the input text sequences 502.

Referring now specifically to FIG. 5A, in some implementations, the speech encoder 204 processes audio input (e.g., reference speech representations 504) and the text encoder 202 processes text input (e.g., input text sequences 502). Each of the speech encoder 204 and the text encoder 202 includes a Conformer encoder including a stack of conformer blocks each of which includes a series of multi-headed self attention, depth wise convolution, and feed-forward layers. Each of the speech encoder 204 and the text encoder 202 may naturally be split into a feature encoder, including the convolution sub sampling block 212, and a context network, including the linear layer 214 and the stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed non-synthetic speech utterance 304 and each reference speech representations 504 and input text sequence 502, and generates, as output, for each of a plurality of output steps, the encoded audio feature 211 that corresponds to a respective one of the reference speech representations 504. The convolution subsampling block 212 may receive, as input, each alignment output 402 and generate, as output, for each of the plurality of output steps, the encoded textual feature 213 that corresponds to a respective one of the alignment outputs 402.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. Thereafter, a contrastive loss module 515 derives a contrastive loss (L_{w2v}) 516 between the contrastive context vectors 215 at the masked positions and the target context vectors 219 as follows according to Equation 3.

The contrastive loss 516 is optimized between the contrastive context vectors 215 at the masked positions and the target context vectors 219. The contrastive loss (L_{w2v}) is optimized for both synthetic speech and the input text sequences 502 represented by alignment outputs 402. Accordingly, the contrastive part 500a of the training process 500 trains the speech encoder 204 and the text encoder 202 on the derived contrastive loss 516 applied on the corresponding encoded features 211, 213 associated with each alignment output 402 and each reference speech representations 504 provided as input to the speech encoder 204 or the text encoder 202. Training the speech encoder 204 and/or the text encoder 202 may include updating parameters of the speech encoder 204 and/or the text encoder 202 based on the contrastive losses 516. In some implementations, the contrastive loss module 515 determines a masked language modeling (MLM) loss 518 for the speech input (e.g., reference speech representations 504) by comparing the contrastive context vector 215 generated from masked encoded features to contrastive context vectors 215 generated from corresponding unmasked encoded features. Thus, the MLM loss 518 compares the encodings generated for masked and unmasked encoded features.

Referring now to FIG. 5B, the TTS supervised loss part 500b of the training process 500 is configured to inject lexical information into the text encoder 202 of the TTS model 501 during training based on supervised loss terms 542, 544 derived from the reference speech representations 504 and the alignment outputs 402 corresponding to input text sequences 502. In contrast, to the ASR supervised loss part 300b (FIG. 3B), the TTS supervised loss part 500 also employs a speech decoder 520 and determines a reconstruction loss 545. The TTS supervised loss part 500b leverages one or more ASR decoders 390 for generating the supervised loss terms (i.e., ASR loss) 542, 544. The ASR decoders 390 may include Connectionist Temporal Classification (CTC) decoders, Listen Attend Spell (LAS) decoders, or RNN-T decoders. These ASR decoders 390 may include at least one of a phoneme decoder configured to decode a sequence of phonemes or a wordpiece decoder configured to decode a sequence of word pieces. The ASR decoders 390 could also include a grapheme decoder configured to decode a sequence of graphemes.

During the TTS supervised loss part 500b, the text encoder 202 is configured to receive alignment outputs 402 (i.e., text embeddings) from the alignment model 400 and the speech encoder 204 is configured to receive the reference speech representations 504. That is, the text encoder 202 generates encoded textual representations 512 for alignment outputs 402 (e.g., corresponding to an input text sequence 502) and the speech encoder 204 generates encoded audio representations 514 for speech inputs (i.e., reference speech representations 504 of the TTS utterances). Here, the encoded textual representations 512 and the encoded audio representations 514 may not both be compatible with the ASR decoders 390. In some examples, the text encoder 202 obtains a corresponding speaker embedding 326 that characterizes speaker characteristics of a corresponding speaker that spoke the ASR utterance in the respective language and generates the corresponding encoded textual representation 512 based on a concatenation of the corresponding alignment output 402 (or the corresponding input text sequence 502) and the corresponding speaker embedding 326.

Thus, the TTS supervised loss part 500b may employ the shared encoder 250 that receives the encoded textual representations 512 as input, and generates a first encoded shared representation 532 (eₜₑₓₜ) as output. Similarly to the text encoder 202, the TTS model 501 and the ASR model 200 may share the shared encoder 250. Moreover, the shared encoder 250 receives the encoded audio representations 514 as input, and generates a second encoded shared representation (eₛᵤₚ) 534 as output. Accordingly, the shared encoder 250 generates the first and second encoded shared representations 532, 534 into a shared latent representation space compatible with the ASR decoder 390.

In particular, the shared encoder 250 receives, as input, each encoded textual representation 512 that corresponds to the alignment output 402 generated from the input text sequence 502 and generates, as output, for each of a plurality of time steps, the first encoded shared representation (eₜₑₓₜ) 532 that corresponds to the alignment output 402 at the corresponding output step. The ASR decoder 390 including the phoneme decoder or the wordpiece decoder receives, as input, each first encoded shared representation 532 output from the shared encoder 250 and generates, as output, a first probability distribution 592 over possible speech recognition hypotheses for the corresponding alignment output 402 at the corresponding output step. The first probability distribution 592 may represent a candidate transcription for the corresponding TTS utterance. In some examples, the first probability distribution 592 over possible speech recognition hypotheses includes one of possible phoneme labels, possible word piece labels, or possible grapheme labels. Thereafter, a TTS supervised loss module 540 may determine an alignment output loss term 542 based on the first probability distribution 592 over possible speech recognition hypotheses for the alignment output 402 corresponding to the input text sequence 502. Here, the corresponding input text sequence 502 in which the alignment output 402 is generated from also serves as a ground-truth transcription. Since the alignment output 402 may be masked (FIG. 4), the alignment output loss term 542 also serves as an aligned MLM loss. The TTS supervised loss part 500b may train the text encoder 202 and/or speech encoder 204 on the alignment output loss term (i.e., ASR loss) 542 by updating parameters of the text encoder 202 and/or the speech encoder 204 based on the alignment output loss term 542.

Similarly, during the TTS supervised loss part 500b, the shared encoder 250 receives, as input, each transcribed encoded audio representation 514 that corresponds to the reference speech representation 504 and generates, as output, for each of a plurality of time steps, a second encoded shared representation (esup) 534 that corresponds to the reference speech representation 504 at the corresponding time step. The ASR decoder 390 including the phoneme decoder or the wordpiece decoder receives, as input, each second encoded shared representation 534 output from the shared encoder 250 and generates, as output, a second probability distribution 594 over possible synthetic speech recognition hypotheses for the corresponding reference speech representation 504 at the corresponding time step. The first probability distribution 592 may represent a candidate transcription for the corresponding TTS utterance. In some examples, the second probability distribution 594 over possible synthetic speech recognition hypotheses includes the one of possible phoneme labels, the possible word piece labels, or the possible grapheme labels. Thereafter, the TTS supervised loss module 540 may determine a synthetic speech loss term 544 based on the second probability distribution 594 over possible synthetic speech recognition hypotheses and the corresponding input text sequence 502 paired with the transcribed reference speech representation 504. Here, the corresponding input text sequence 502 serves as a ground-truth transcription and may include a sequence of target phonemes, target word pieces, and/or target graphemes. The TTS supervised loss part 500b may train the text encoder 202 and/or speech encode 204 on the synthetic speech loss term (i.e., ASR loss) 544 by updating parameters of the text encoder 202 and/or speech encoder 204 based on the synthetic speech loss term 544.

In some examples, the TTS supervised loss part 500b determines modality matching losses 505 between the speech encodings 514 generated for the TTS utterances using the speech encoder 204 and the TTS encoded textual representations 512 generated for the input text sequences 502. That is, the TTS supervised loss part 500b compares the speech encodings 514 and the TTS encoded textual representations 512 that each correspond to a same utterance to determine the modality matching loss 505. Thereafter, the supervised loss part 500b trains the speech encoder 204 and/or text encoder 202 based on the modality matching losses 505.

The TTS supervised loss part also employs the speech decoder 520 that may include a RNN-T architecture. The speech decoder 520 may be part of the TTS model 501 whereby the speech decoder 520 is configured to receive the first or second encoded shared representation 532, 534 (collectively referred to as the shared encoder output 532, 534) and generate a predicted speech representation 522 for the corresponding TTS utterance of synthetic speech represented by the reference speech representation 504 or the alignment output 402 generated from the input text sequence 502. In some examples, the speech decoder 520 obtains a corresponding variational embedding 528 that specifies an intended prosody/style for the predicted speech representation 522 whereby the speech encoder is 520 is conditioned on the corresponding variational embedding 528 and the corresponding speaker embedding 326. The predicted speech representation 522 represents features of synthetic speech the TTS model 501 would generate for the TTS utterance 510. Thus, the reconstruction loss 545 based on the predicted speech representation 522 and the corresponding reference speech representation 504 which serves as a ground-truth label from which the predicted speech representation 522 was generated from. The training process 500 trains the speech encoder 202, the text encoder 204, the shared encoder 250, and/or the speech decoder 520 based on the reconstruction losses 545 generated for each TTS utterance 510.

Referring to FIG. 5C, the consistency regularization part (i.e., modality matching part) 500c of the training process 500 is configured to promote the text encoder 202 and the speech encoder 204 to learn consistent predictions between synthetic speech and alignment outputs 402 corresponding to the input text sequences 502 by generating a consistent loss term ( [symbol] _{cons}(θ)) 552 between training utterance pairs 503 that each include a corresponding one of the reference speech representations 504 and a paired alignment output 404 of the same utterance as the corresponding reference speech representation 504. As such, the reference speech representation and the paired alignment output 404 of each training utterance pair 503 is associated with a same ground-truth transcription. In short, the consistent loss term 552 between the reference speech representation 504 and paired alignment output 404 of the same training utterance provides an unsupervised training aspect by encouraging the speech encoder 204 and the text encoder 202 to behave consistently regardless of whether the training utterance belongs to synthetic speech or the alignment output (i.e., text training data) and independent of supervised loss terms between the ground-truth transcription (i.e., input text sequence) 502 and each of the speech recognition hypothesis output by the auxiliary decoder 390.

Similar to the alignment outputs 402 generated from the input text sequences 502 in FIG. 5B, the alignment model 400 may generate each paired alignment output 404 using the corresponding input text sequence 502 that is paired with the reference speech representation 503. Here, the reference speech representation 504 is associated with paired alignment output 404 generated by the alignment model 400 mapping the input text sequence 502 into speech frames.

During the consistency regularization part 500c, the text encoder 202 receives, as input, each paired alignment output 404 and generates, as output, for each of a plurality of time steps, an encoded textual representation 513 that corresponds to the paired alignment output 404 at the corresponding output step. In some examples, the text encoder 202 obtains a corresponding speaker embedding 326 that characterizes speaker characteristics of a corresponding speaker that spoke the ASR utterance in the respective language and generates the corresponding encoded textual representation 512 based on a concatenation of the corresponding alignment output 402 (or the corresponding input text sequence 502) and the corresponding speaker embedding 326. The shared encoder 250 receives, as input, the encoded textual representation 513 and generates, as output, a first encoded shared representation (e*ₛᵤₚ) 523. The auxiliary decoder 390 including the phoneme decoder or the wordpiece decoder receives, as input, each first encoded shared representation 523 output from the shared encoder 250 and generates, as output, a first probability distribution 511 over possible speech recognition hypotheses for the corresponding paired alignment output 404 at the corresponding output step. In some examples, the first probability distribution 511 over possible speech recognition hypotheses includes one of possible phoneme labels or possible word piece labels.

Similarly, the speech encoder 204 receives, as input, each reference speech representation 504 as a sequence of features/vectors (e.g., mel-frequency spectrograms such as the acoustic frames 110 of FIG. 1) and generates, as output, for each of a plurality of time steps, an encoded audio representation 514 that corresponds to the reference speech representation 504 at the corresponding output step. The shared encoder 250 receives, as input, the encoded audio representation 514 and generates, as output, a second encoded shared representation (esup) 534. The auxiliary decoder 390 including the phoneme decoder or the wordpiece decoder receives, as input, each second encoded shared representation 534 output from the shared encoder 250 and generates, as output, a second probability distribution 594 over possible non-synthetic speech recognition hypotheses for the corresponding reference speech representation 504 at the corresponding time step. In some examples, the second probability distribution 594 over possible non-synthetic speech recognition hypotheses includes the one of the possible phoneme labels or the possible word piece labels.

With continued reference to FIG. 5C, the consistency regularization part 500c of the training process 500 further determines, at each of the plurality of output steps for each training utterance pair 503, the consistent loss term ( [symbol] _{cons}(θ)) 352 for the corresponding training utterance pair 503 based on the first probability distribution 511 over possible speech recognition hypotheses and the second probability distribution 594 over possible non-synthetic speech recognition hypotheses. For instance, the training process 500 may employ a consistency loss term module 550 configured to receive, at each time step, the corresponding non-synthetic speech and speech recognition results 511, 594 output by the auxiliary decoder 390, and determine the consistency loss term 552 for the corresponding training utterance pair 503 at the time step.

In some examples, the consistency regularization part 500c of the training process 500 determines the consistent loss term 552 based on a Kullback-Leibler divergence (D_{KL}) between the first probability distribution 511 over possible speech recognition hypotheses and the second probability distribution 594 over possible non-synthetic speech recognition hypotheses. The consistent loss term 552 based on D_{KL} may be expressed by Equation 8. Here, the consistent loss term 552 determined for the training utterance pair 503 at each time step provides an “unsupervised” loss term that is independent of the accuracy of the auxiliary decoder 390, and thus, may be employed to update parameters of the speech encoder 204 and/or the text encoder 202 for promoting consistency between synthetic speech representations and alignment outputs of the same utterances. In batch training, the consistent loss term 552 may correspond to an average loss term obtained for the batch. In other words, the consistent loss term 552 permits the text encoder 202 and the speech encoder 204 to learn to behave the same, e.g., make consistent encoded representation predictions on both synthetic speech and alignment outputs of a same training utterance, regardless of whether the training utterance belongs to non-synthetic speech or alignment outputs.

In short, the training processes 300 and 500 train the TTS model 500 that includes the text encoder 202 and the speech decoder 520 during inference. The training process 300 trains the TTS model 500 using ASR utterances of non-synthetic speech including transcribed speech utterance, un-transcribed speech utterances, and unspoken text. The training process 500 trains the TTS model 500 using TTS utterances of synthetic speech including speech representations paired with input text sequences. Moreover, the training processes 300, 500 train the TTS model 500 with training data from multiple different languages such that the training processes 300, 500 train the TTS model 500 to be multilingual. By training the TTS model 500 on each of the losses (or any combination of losses) derived from the training processes 300, 500, the TTS model 500 may scale to a massive multilingual TTS model even for languages with little or no training data. In particular, the training processes 300, 500 utilize textual input training data to train the TTS model 500 by generating the alignment outputs 402. That is, the alignment outputs 402 enable training for the TTS model 500 on text inputs without having to synthesize the text input.

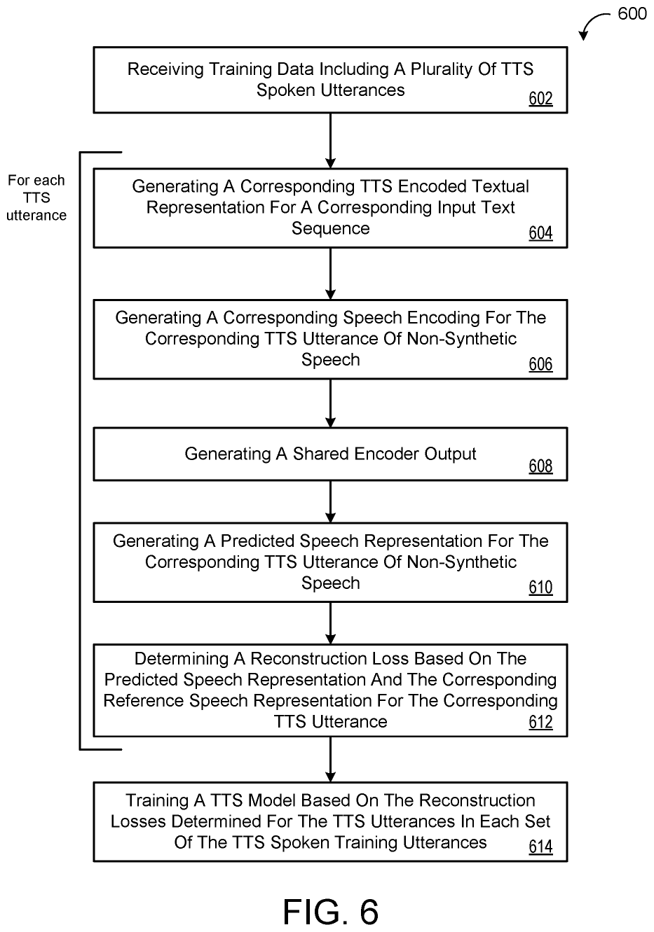

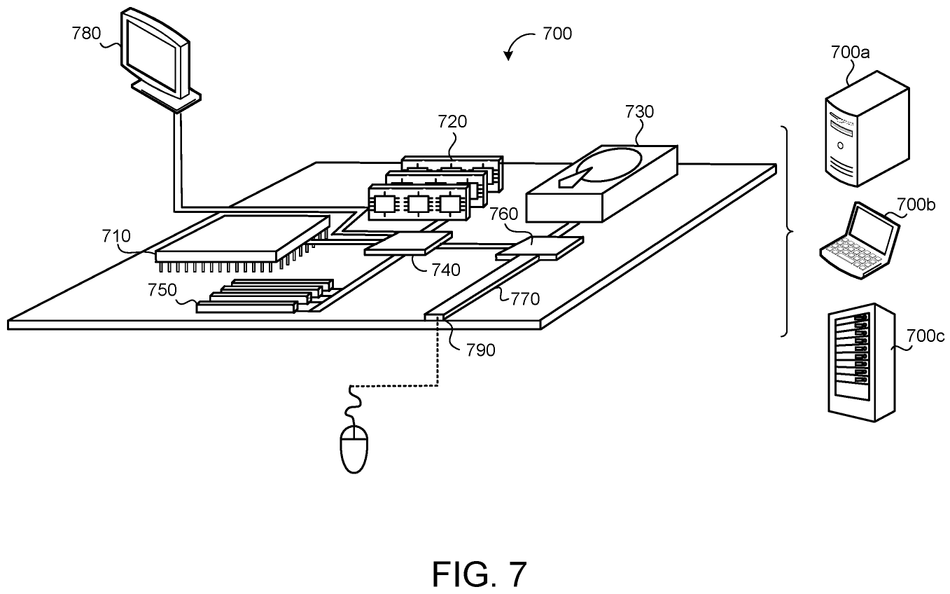

FIG. 6 is flowchart of an example arrangement of operations for a computer-implemented method 600 of massive multilingual speech-text joint semi-supervised learning for text-to-speech. The method 600 may execute on data processing hardware 710 (FIG. 7) using instructions stored on memory hardware 720 (FIG. 7). The data processing hardware 710 and the memory hardware 720 may reside on the user device 102 and/or the remote computing device 201 of FIG. 1 each corresponding to a computing device 700 (FIG. 7).

At operation 602, the method 600 includes receiving training data 301 that includes a plurality of sets of TTS spoken utterances 510. Each set of the TTS spoken utterances 510 is associated with a respective language from among a plurality of different languages that is different than the respective language associated with each other set of the TTS spoken utterances 510. Moreover, each set of the TTS spoken utterances includes TTS utterances 510 of synthetic speech spoken in the respective language. Each TTS utterance 510 of synthetic speech includes a corresponding reference speech representation 504 paired with a corresponding input text sequence 502. For each TTS utterance 510 in each set of the TTS spoken training utterances 510 of the received training data 301, the method 600 performs operations 604-612. At operation 604, the method 600 includes generating a corresponding TTS encoded textual representation 512 for the corresponding input text sequence 502 using a text encoder 202. At operation 604, the method 600 includes generating a corresponding speech encoding 514 for the corresponding TTS utterance 510 of synthetic speech using a speech encoder 204 and, at operation 608, the method 600 includes generating a shared encoder output 532, 534 using a shared encoder 250 configured to receive the corresponding TTS encoded textual representation 512 or the corresponding speech encoding 514. At operation 610, the method 600 includes generating a predicted speech representation 522 for the corresponding TTS utterance 510 of synthetic speech using a speech decoder 520 configured to receive the shared encoder output 532, 534. At operation 612, the method 600 includes determining a reconstruction loss 545 based on the predicted speech representation 522 and the corresponding reference speech representation 504 for the corresponding TTS utterance 510. At operation 614, the method 600 includes training a TTS model 501 based on the reconstruction losses 545 determined for the TTS utterances 510 in each set of the TTS spoken training utterances 510 to teach the TTS model 501 to learn how to synthesize speech in each of the plurality of different languages.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 740 connecting to a low speed bus 770 and a storage device 730. Each of the components 710, 720, 730, 740, 750, and 740, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 740 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 740 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving training data comprising a plurality of sets of text-to-speech (TTS) spoken utterances, each set of the TTS spoken utterances associated with a respective language from among a plurality of different languages that is different than the respective language associated with each other set of the TTS spoken utterances and comprising TTS utterances of synthetic speech spoken in the respective language, each TTS utterance of synthetic speech comprising a corresponding reference speech representation paired with a corresponding input text sequence;
for each TTS utterance in each set of the TTS spoken utterances of the received training data:
generating, using a text encoder, a corresponding TTS encoded textual representation for the corresponding input text sequence;
generating, using a speech encoder, a corresponding speech encoding for the corresponding TTS utterance of synthetic speech;
generating, using a shared encoder configured to receive the corresponding TTS encoded textual representation or the corresponding speech encoding, a shared encoder output;
generating, using a speech decoder configured to receive the shared encoder output, a predicted speech representation for the corresponding TTS utterance of synthetic speech; and
determining a reconstruction loss based on the predicted speech representation and the corresponding reference speech representation for the corresponding TTS utterance; and
training a TTS model based on the reconstruction losses determined for the TTS utterances in each set of the TTS spoken training utterances to teach the TTS model to learn how to synthesize speech in each of the plurality of different languages.

2. The computer-implemented method of claim 1, wherein the operations further comprise, for each TTS utterance in each set of the TTS spoken training utterances of the received training data:
obtaining a corresponding speaker embedding characterizing speaker characteristics of a corresponding speaker that spoke the TTS utterance of synthetic speech in the respective language; and
obtaining a corresponding variational embedding that specifies an intended prosody/style for the predicted speech representation generated for the corresponding TTS utterance of synthetic speech,
wherein, when generating the corresponding TTS encoded textual representation for the corresponding input text sequence, the text encoder is configured to receive a concatenation of the corresponding input text sequence and the corresponding speaker embedding, and
wherein, when generating the predicted speech representation for the corresponding TTS utterance of synthetic speech, the speech decoder is conditioned on the corresponding variational embedding and the corresponding speaker embedding.

3. The computer-implemented method of claim 1, wherein the operations further comprise, for each TTS utterance in each set of the TTS spoken training utterances of the received training data:
generating, using an automatic speech recognition (ASR) decoder configured to receive the shared encoder output, a sequence of speech recognition hypotheses representing a candidate transcription for the corresponding TTS utterance of synthetic speech; and
determining an ASR loss based on the sequence of speech recognition hypotheses and the corresponding input text sequence,
wherein training the TTS model is further based on the ASR losses determined for the TTS utterances in each set of the TTS spoken training utterances.

4. The computer-implemented method of claim 1, wherein:
the training data further comprises a plurality of sets of automatic speech recognition (ASR) transcribed utterances, each set of the ASR transcribed utterances associated with a respective language that is different than the respective language associated with each other set of the ASR transcribed utterances and comprising ASR utterances of non-synthetic speech spoken in the respective language, each ASR utterance of non-synthetic speech paired with a corresponding transcription; and
training the TTS model further comprises training the TTS model on the plurality of sets of ASR transcribed utterances.

5. The computer-implemented method of claim 1, wherein the speech decoder comprises a recurrent neural network-transducer (RNN-T) architecture.

6. The computer-implemented method of claim 1, wherein the operations further comprise:
determining consistency losses between the speech encodings generated for the TTS utterances of synthetic speech using the speech encoder and the TTS encoded textual representations generated for the input text sequences,
wherein training the TTS model is further based on the consistency losses.

7. The computer-implemented method of claim 1, wherein the operations further comprise:
determining modality matching losses between the speech encodings generated for the TTS utterances of synthetic speech using the speech encoder and the TTS encoded textual representations generated for the input text sequences,
wherein training the TTS model is further based on the modality matching losses.

8. The computer-implemented method of claim 1, wherein the operations further comprise:
obtaining a masked language modeling (MLM) loss for the speech encodings generated for the TTS utterances of synthetic speech using the speech encoder; and
obtaining an aligned MLM loss for the TTS encoded textual representations generated for the input text sequences using the text encoder,
wherein training the TTS model further comprises training the TTS model on the MLM loss and the aligned MLM loss.

9. The computer-implemented method of claim 1, wherein:
the training data further comprises unspoken textual utterances in a respective plurality of different languages, each unspoken textual utterance not paired with any corresponding spoken utterance of synthetic speech; and
the operations further comprise, for each unspoken textual utterance:
generating, using the text encoder, a corresponding unspoken encoded textual representation for the corresponding unspoken textual utterance; and
obtaining an aligned masked language modeling (MLM) loss for the corresponding unspoken encoded textual representation generated for the corresponding unspoken textual utterance,
wherein training the TTS model further comprises training the TTS model based on the aligned MLM loss obtained for the unspoken encoded textual representation.

10. The computer-implemented method of claim 1, wherein:
the training data further comprises un-transcribed non-synthetic speech utterances in a respective plurality of different languages, each un-transcribed non-synthetic speech utterance not paired with a corresponding transcription; and
the operations further comprise, for each un-transcribed non-synthetic speech utterance:
generating, using the speech encoder, a corresponding speech encoding for the corresponding un-transcribed non-synthetic speech utterance; and
obtaining a masked language modeling (MLM) loss for the corresponding speech encoding generated for the corresponding un-transcribed non-synthetic speech utterance,
wherein training the TTS model further comprises training the TTS model based on the MLM loss obtained for the corresponding speech encoding.

11. The computer-implemented method of claim 1, wherein the TTS model comprises the text encoder and the speech decoder.

12. The computer-implemented method of claim 1, wherein each corresponding input text sequence comprises a sequence of graphemes, word-piece-model units, phonemes, or bytes.

13. A system comprising:
data processing hardware; and
memory hardware in communication with the data processing hardware, the memory hardware storing instructions that when executed on the data processing hardware cause the data processing hardware to perform operations comprising:
receiving training data comprising a plurality of sets of text-to-speech (TTS) spoken utterances, each set of the TTS spoken utterances associated with a respective language from among a plurality of different languages that is different than the respective language associated with each other set of the TTS spoken utterances and comprising TTS utterances of synthetic speech spoken in the respective language, each TTS utterance of synthetic speech comprising a corresponding reference speech representation paired with a corresponding input text sequence;
for each TTS utterance in each set of the TTS spoken training utterances of the received training data:
generating, using a text encoder, a corresponding TTS encoded textual representation for the corresponding input text sequence;
generating, using a speech encoder, a corresponding speech encoding for the corresponding TTS utterance of synthetic speech;
generating, using a shared encoder configured to receive the corresponding TTS encoded textual representation or the corresponding speech encoding, a shared encoder output;
generating, using a speech decoder configured to receive the shared encoder output, a predicted speech representation for the corresponding TTS utterance of synthetic speech; and
determining a reconstruction loss based on the predicted speech representation and the corresponding reference speech representation for the corresponding TTS utterance; and
training a TTS model based on the reconstruction losses determined for the TTS utterances in each set of the TTS spoken training utterances to teach the TTS model to learn how to synthesize speech in each of the plurality of different languages.

14. The system of claim 13, wherein the operations further comprise, for each TTS utterance in each set of the TTS spoken training utterances of the received training data:
obtaining a corresponding speaker embedding characterizing speaker characteristics of a corresponding speaker that spoke the TTS utterance of synthetic speech in the respective language; and
obtaining a corresponding variational embedding that specifies an intended prosody/style for the predicted speech representation generated for the corresponding TTS utterance of synthetic speech,
wherein, when generating the corresponding TTS encoded textual representation for the corresponding input text sequence, the text encoder is configured to receive a concatenation of the corresponding input text sequence and the corresponding speaker embedding, and
wherein, when generating the predicted speech representation for the corresponding TTS utterance of synthetic speech, the speech decoder is conditioned on the corresponding variational embedding and the corresponding speaker embedding.

15. The system of claim 13, wherein the operations further comprise, for each TTS utterance in each set of the TTS spoken training utterances of the received training data:
generating, using an automatic speech recognition (ASR) decoder configured to receive the shared encoder output, a sequence of speech recognition hypotheses representing a candidate transcription for the corresponding TTS utterance of synthetic speech; and
determining an ASR loss based on the sequence of speech recognition hypotheses and the corresponding input text sequence,
wherein training the TTS model is further based on the ASR losses determined for the TTS utterances in each set of the TTS spoken training utterances.

16. The system of claim 13, wherein:
the training data further comprises a plurality of sets of automatic speech recognition (ASR) transcribed utterances, each set of the ASR transcribed utterances associated with a respective language that is different than the respective language associated with each other set of the ASR transcribed utterances and comprising ASR utterances of non-synthetic speech spoken in the respective language, each ASR utterance of non-synthetic speech paired with a corresponding transcription; and
training the TTS model further comprises training the TTS model on the plurality of sets of ASR transcribed utterances.

17. The system of claim 13, wherein the speech decoder comprises a recurrent neural network-transducer (RNN-T) architecture.

18. The system of claim 13, wherein the operations further comprise:
determining consistency losses between the speech encodings generated for the TTS utterances of synthetic speech using the speech encoder and the TTS encoded textual representations generated for the input text sequences,
wherein training the TTS model is further based on the consistency losses.

19. The system of claim 13, wherein the operations further comprise:
determining modality matching losses between the speech encodings generated for the TTS utterances of synthetic speech using the speech encoder and the TTS encoded textual representations generated for the input text sequences,
wherein training the TTS model is further based on the modality matching losses.

20. The system of claim 13, wherein the operations further comprise:
obtaining a masked language modeling (MLM) loss for the speech encodings generated for the TTS utterances of synthetic speech using the speech encoder; and
obtaining an aligned MLM loss for the TTS encoded textual representations generated for the input text sequences using the text encoder,
wherein training the TTS model further comprises training the TTS model on the MLM loss and the aligned MLM loss.

21. The system of claim 13, wherein:
the training data further comprises unspoken textual utterances in a respective plurality of different languages, each unspoken textual utterance not paired with any corresponding spoken utterance of synthetic speech; and
the operations further comprise, for each unspoken textual utterance:
generating, using the text encoder, a corresponding unspoken encoded textual representation for the corresponding unspoken textual utterance; and
obtaining an aligned masked language modeling (MLM) loss for the corresponding unspoken encoded textual representation generated for the corresponding unspoken textual utterance,
wherein training the TTS model further comprises training the TTS model based on the aligned MLM loss obtained for the unspoken encoded textual representation.

22. The system of claim 13, wherein:
the training data further comprises un-transcribed non-synthetic speech utterances in a respective plurality of different languages, each un-transcribed non-synthetic speech utterance not paired with a corresponding transcription; and
the operations further comprise, for each un-transcribed non-synthetic speech utterance:
generating, using the speech encoder, a corresponding speech encoding for the corresponding un-transcribed non-synthetic speech utterance; and
obtaining a masked language modeling (MLM) loss for the corresponding speech encoding generated for the corresponding un-transcribed non-synthetic speech utterance,
wherein training the TTS model further comprises training the TTS model based on the MLM loss obtained for the corresponding speech encoding.

23. The system of claim 13, wherein the TTS model comprises the text encoder and the speech decoder.

24. The system of claim 13, wherein each corresponding input text sequence comprises a sequence of graphemes, word-piece-model units, phonemes, or bytes.
